(19) United States
(12) Patent Application Publication
(10) Pub. No.: US 2026/0301496 A1
(43) Pub. Date: Oct. 1, 2026

(54) VARIABLE FREQUENCY DRIVES - KEYPAD ADAPTOR

(71) Applicant: Schneider Electric USA, Inc., Andover, MA (US)

(72) Inventors: Victor Gasulla, Andover, MA (US); Fabio Cavalheiro, Andover, MA (US)

(73) Assignee: Schneider Electric USA, Inc., Boston, MA (US)

(21) Appl. No.: 19/089,247

(22) Filed: Mar. 25, 2025

(51) Int. Cl. G07C 9/00; E05B 49/00

(52) U.S. Cl. CPC G07C 9/00944; E05B 49/00; G07C 9/00674; G07C 9/00912

(57) ABSTRACT

A method includes semi-permanently affixing a mounting structure with an adapter to a front face of a cabinet door of a VFD cabinet, including affixing the mounting structure over and covering a preexisting opening in the cabinet door, the preexisting opening being sized for a legacy keypad and the adapter being shaped to support and hold an upgraded keypad. The method further includes semi-permanently affixing the upgraded keypad to the adapter, including physically and communicatively coupling a keypad electrical interface of the upgraded keypad to an adapter port of the adapter. The method further includes extending an electrical conductor portion of the adapter through an aperture in the mounting structure for allowing access to an electrical conductor of the electrical conductor portion via the preexisting opening and communicatively coupling the electrical conductor adapter to the adapter port and to a VFD electrical interface of the VFD cabinet.

### FIELD

This disclosure relates generally to variable frequency drive (VFD) cabinets, and more particularly, to an adapter and method for upgrading a VFD cabinet with an upgraded keypad.

### BACKGROUND

A variable frequency drive (VFD) is a device that controls the speed and torque of an AC motor by varying the frequency and voltage of its power supply, allowing for precise control over the motor's performance. VFDs can improve energy efficiency of the motor, reduce mechanical stress in the motor, and/or extend lifespan of the motor. VFDs can be used for various applications, including industrial machinery, pumps, fans, conveyors, and heating, ventilation, and air conditioning systems (HVAC) systems.

The VFD can operate in a dirty environment in which contaminants, dust, and/or moisture abound that could be harmful to the VFD. The VFD is housed in a cabinet that protects the VFD from environmental factors, such as for shielding the VFD from dust, moisture, and other contaminants that could damage its electronic components. The cabinet is further provided for safety purposes, e.g., to reduce the risk of electrical shock to operators and technicians in the vicinity. In certain settings, such as a meat processing plant, regulations require that the VFD cabinet be cleaned from contaminants. The cabinet therefore further protects the VFD while the cabinet is being washed down.

The VFD cabinet is provided with a keypad that provides a user interface device accessible to users for allowing an operator to control and configure the VFD while keeping the cabinet door closed. Some key features and functions of a VFD keypad can include, for example, a display screen, control buttons, programming capabilities. The display screen can display information, such as motor speed, frequency, voltage, and diagnostic information. The control buttons can interact with the motor, such as to start, stop, and adjust speed of the motor. The control buttons can be used to navigate through different menus and settings. The programming capabilities can use the control buttons and display screen to interact with and program a processor of the VFD, such as programming the processor with setting parameters for the motor (e.g., acceleration and deceleration times, maximum and minimum speeds).

As technology develops, new generations of VFDs are produced. The upgrade calls for a newly designed keypad that can access new functionality of the VFD.

### SUMMARY

The purpose and advantages of the below described illustrated embodiments will be set forth in and apparent from the description that follows. Additional advantages of the illustrated embodiments will be realized and attained by the devices, systems and methods particularly pointed out in the written description and claims hereof, as well as from the appended drawings. To achieve these and other advantages and in accordance with the purpose of the illustrated embodiments, in one aspect, disclosed is a keypad adapter assembly that includes a mounting structure, an adapter, and an adapter port. The mounting structure is configured to be semi-permanently affixed to a front face of a cabinet door of a variable frequency drive (VFD) cabinet housing one or more VFDs and to cover a preexisting opening in the cabinet door, the preexisting opening being sized for a legacy keypad. The adapter has a front face that is configured to support and hold an upgraded keypad having a different size than the legacy keypad, the adapter being configured to be permanently or semi-permanently affixed to the mounting structure. The adaptor port mates with a keypad electrical interface of the upgraded keypad for establishing a communicative coupling for exchanging signals between the adaptor port and the keypad electrical interface. The adapter includes an electrical conductor portion having an electrical conductor configured to communicatively couple the adaptor port to a VFD electrical interface of the VFD cabinet for exchanging signals.

In one or more embodiments, the communicative coupling of the electrical conductor and the adapter port can be performed inside a protected area defined by at least a housing of the electrical conductor portion and the communicative coupling of the electrical conductor and the VFD electrical interface can be performed outside the protected area.

In one or more embodiments, the electrical conductor portion can include an insulative housing that houses the electrical conductor, a first end of the electrical conductor exiting the insulative housing for communicatively coupling with the adapter port and a second end of the electrical conductor exiting the insulative housing at a conductor port that is configured to receive a connector coupled to the VFD electrical interface for facilitating the communicative coupling with the VFD electrical interface.

In one or more embodiments, the keypad adapter assembly can further include an adaptive cap that can enclose the insulative housing and provide access to the conductor port.

In one or more embodiments, the keypad adapter assembly can further include a first sealing structure configured to seal an interface between the insulative housing the mounting structure to prevent entry of contaminants or tampering into the protected area.

In one or more embodiments, the keypad adapter assembly can further include a first sealing structure, wherein the first sealing structure and an outer surface of the electrical conductor portion can have first cooperative fastening structures configured to be fastened to each other for securing the first sealing structure to the electrical conductor portion when the electrical conductor portion extends through the aperture in the mounting structure, wherein fastening the cooperative fastening structures can enhance the affixation of the adapter to the mounting structure, and/or wherein the first sealing structure and the adapter have second cooperative fastening structures can be configured to be fastened to each other for securing the adapter to the first sealing structure.

In one or more embodiments, the mounting structure and the adapter can further include cooperating alignment structures to facilitate alignment of the adapter and the mounting structure.

In one or more embodiments, the keypad adapter assembly can further include a second sealing structure configured to be disposed between the mounting structure and the preexisting opening in the cabinet door when the mounting structure is positioned to cover the preexisting opening in the cabinet door, and the second sealing structure can further be configured to seal the preexisting opening to protect an interior of the VFD cabinet.

In one or more embodiments, the adapter can include one or more physical structures for semi-permanently affixing the upgraded keypad to the adapter.

In one or more embodiments, the adapter can be configured for tool-free affixation of the of the upgraded keypad to the physical adapter and/or the adapter port can be configured for tool-free mating with the keypad electrical interface.

In one or more embodiments, when sealed by the first sealing structure, the protected area defined by at least the housing of the electrical conductor portion can be totally enclosed.

In one or more embodiments, prior to affixing the mounting structure to the cabinet door, a legacy keypad assembly semi-permanently affixed to the cabinet door can be removed, wherein the legacy keypad assembly was affixed to the cabinet door using one or more first legacy fastening structures engaged with one or more legacy cooperating fastening structures provided with cabinet door. The keypad adapter assembly can further include the one or more first legacy fastening structures, and affixing the mounting structure to the cabinet door can include cooperatively engaging the one or more first legacy fastening structures with the one or more legacy cooperating fastening structures provided with cabinet door.

In accordance with another aspect of the disclosure, a method is disclosed. The method includes semi-permanently affixing a mounting structure with an adapter to a front face of a cabinet door of a VFD cabinet housing one or more VFDs, including affixing the mounting structure over and covering a preexisting opening in the cabinet door, the preexisting opening being sized for a legacy keypad and the adapter being shaped to support and hold an upgraded keypad having a different size than the legacy keypad. The method further includes semi-permanently affixing the upgraded keypad to the adapter, including physically and communicatively coupling a keypad electrical interface of the upgraded keypad to an adapter port of the adapter, the communicative coupling facilitating an exchange of signals. The method further includes extending an electrical conductor portion of the adapter through an aperture in the mounting structure for allowing access to an electrical conductor of the electrical conductor portion via the preexisting opening and communicatively coupling the electrical conductor adapter to the adapter port and to a VFD electrical interface of the VFD cabinet for facilitating an exchange of signals.

In one or more embodiments, the communicative coupling of the electrical conductor and the adapter port can be performed inside a protected area defined by at least a housing of the electrical conductor portion, and the communicative coupling of the electrical conductor to the VFD electrical interface for exchanging signals is performed outside the protected area.

In one or more embodiments, the method can further include securing the electrical conductor portion to the mounting structure for stability and support while preserving access to at least one conductor port that facilitates one or more of connecting the electrical conductor to ground and the communicative coupling with the VFD electrical interface.

In one or more embodiments, the affixing the keypad to the keypad adapter assembly can be a tool-free process.

In one or more embodiments, the method can further include sealing the preexisting opening to protect an interior of the VFD cabinet.

In one or more embodiments, the method can further include removing a semi-permanently affixed legacy keypad assembly mounted over the preexisting opening of the cabinet door.

In accordance with still a further aspect of the disclosure, an upgraded VFD cabinet is provided that houses one or more VFDs. The upgraded VFD cabinet includes a cabinet door of the cabinet, the cabinet door having a preexisting opening sized for a legacy keypad, a mounting structure configured to be semi-permanently affixed to a front face of the cabinet door and to cover the preexisting opening in the cabinet door, and an adapter having a front face that is shaped to support and hold an upgraded keypad having a different size than the legacy keypad. The adapter is configured to be permanently or semi-permanently affixed to the mounting structure. The adapter includes an adapter port and an electrical conductor portion. The adapter mates with a keypad electrical interface of the upgraded keypad for establishing a communicative coupling for exchanging signals between the adapter port and the keypad electrical interface. The electrical conductor portion has an electrical conductor configured to communicatively couple the adapter port to a VFD electrical interface of the VFD cabinet for exchanging signals.

These and other features of the systems and methods of the subject disclosure will become more readily apparent to those skilled in the art from the following detailed description of the preferred embodiments taken in conjunction with the drawings.

### BRIEF DESCRIPTION OF THE DRAWINGS

A more detailed description of the disclosure, briefly summarized above, may be had by reference to various embodiments, some of which are illustrated in the appended drawings. While the appended drawings illustrate select embodiments of this disclosure, these drawings are not to be considered limiting of its scope, for the disclosure may admit to other equally effective embodiments.

FIG. 1 is a front perspective diagram of a legacy variable frequency drive (VFD) cabinet having a legacy keypad being upgraded, while using the same cabinet door, to a VFD cabinet having an upgraded keypad, in accordance with embodiments of the disclosure;

FIG. 2 is a front-perspective view of a keypad mounting kit used for mounting an upgraded keypad in a legacy cabinet door of a VFD cabinet, in accordance with embodiments of the disclosure;

FIG. 3 is a front-perspective exploded view of an adapter, an upgraded faceplate, and a gasket, in accordance with embodiments of the disclosure;

FIG. 4 is a back-perspective exploded view of the adapter, the upgraded faceplate, and the gasket shown in FIG. 3;

FIGS. 5A and 5B are respective front and back perspective views of an upgraded faceplate and an adapter assembled together, in accordance with embodiments of the disclosure;

FIG. 6A is an exploded front-perspective view of the faceplate, the adapter, and the upgraded keypad being assembled, in accordance with embodiments of the disclosure;

FIG. 6B is an exploded front-perspective view of the upgraded keypad assembled with the adapter and being aligned with the faceplate, in accordance with embodiments of the disclosure;

FIG. 6C is an exploded rear-perspective view of the faceplate assembled with an assembly of the adapter and upgraded keypad being aligned with a ring and an electrical adapter, in accordance with embodiments of the disclosure;

FIGS. 7A-7H various views are shown of a series of operations for upgrading a legacy VFD cabinet by assembling a legacy door of the VFD cabinet with an upgraded keypad, in accordance with embodiments of the disclosure; and

FIG. 8 is a flowchart showing an example method of upgrading a legacy VFD cabinet by assembling a legacy door of the VFD cabinet with an upgraded keypad and coupling the upgraded keypad to computer components of the VFD cabinet, in accordance with embodiments of the disclosure.

Identical reference numerals have been used, where possible, to designate identical elements that are common to the figures. However, elements disclosed in one embodiment may be beneficially utilized on other embodiments without specific recitation.

### DETAILED DESCRIPTION

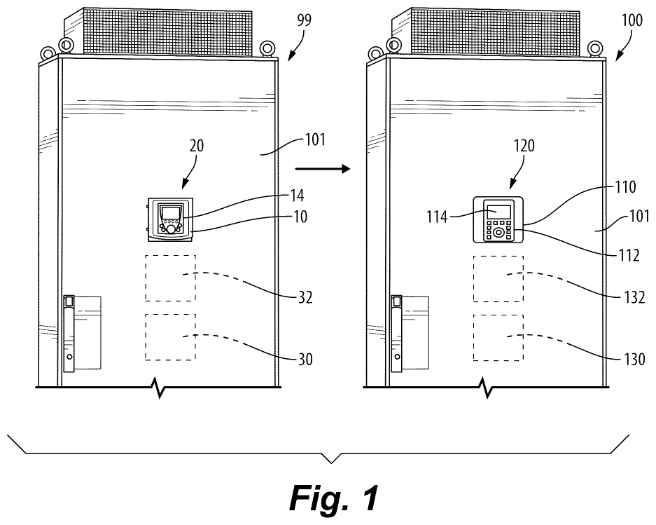

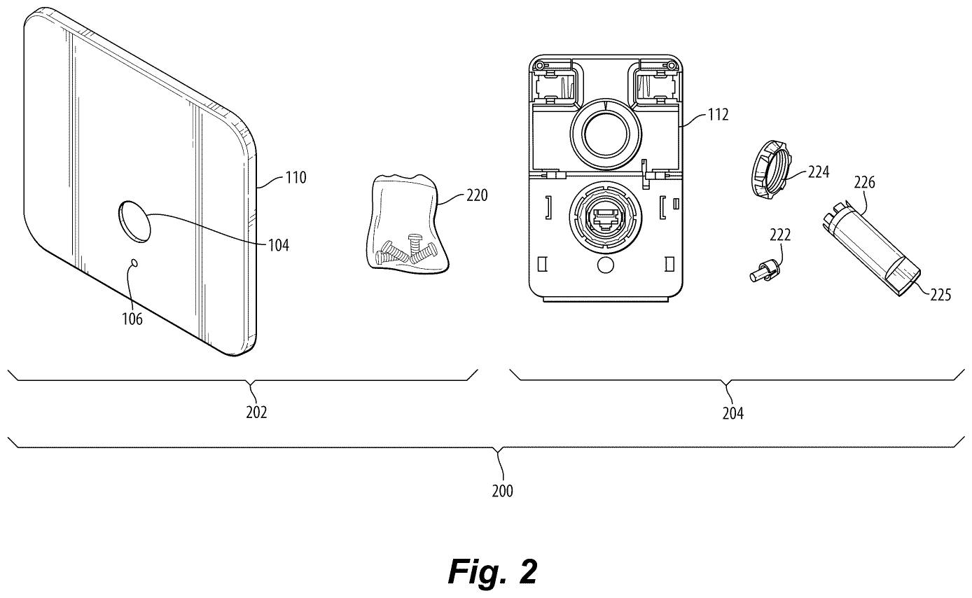

Reference will now be made to the drawings wherein like reference numerals identify similar structural features or aspects of the subject disclosure. For purposes of explanation and illustration, and is not limitation, a block diagram of an exemplary embodiment of a variable frequency drive (VFD) in accordance with the disclosure is shown in FIG. 1 and is designated generally by reference character 100. Other embodiments of the VFD cabinet 100 in accordance with the disclosure, or aspects thereof, are provided in FIGS. 2-8, as will be described.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, exemplary methods and materials are now described.

It must be noted that as used herein and in the appended claims, the singular forms “a,” “an,” and “the” include plural referents unless the context clearly dictates otherwise. Thus, for example, reference to “a stimulus” includes a plurality of such stimuli and reference to “the signal” includes reference to one or more signals and equivalents thereof known to those skilled in the art, and so forth.

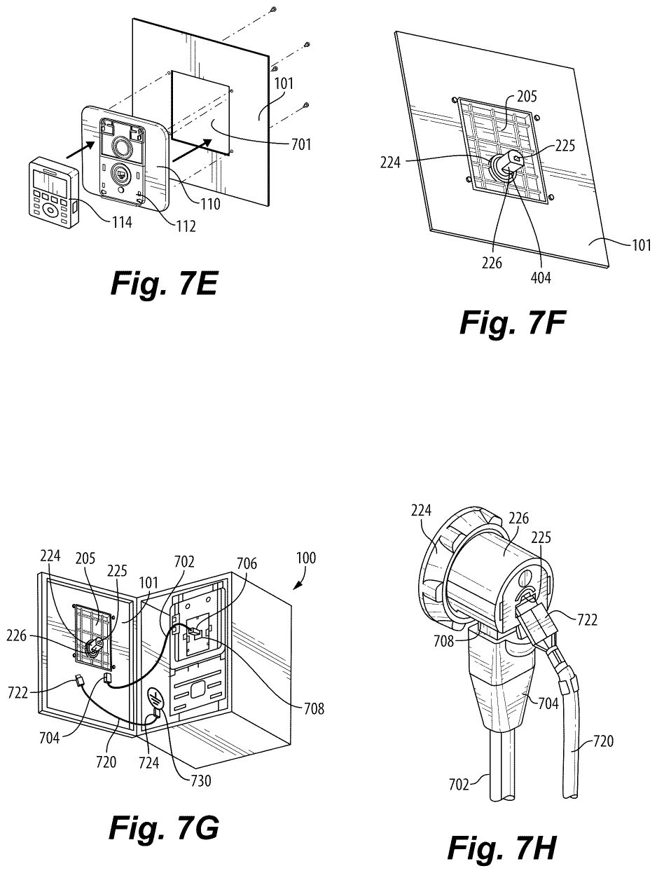

FIG. 1 is a perspective front view of a legacy VFD cabinet 99 in a legacy state (shown to the left of the horizontal arrow) and upgraded VFD cabinet 100, after undergoing an upgrade, in an upgraded state (shown to the right of the horizontal arrow). In the legacy state, a door 101 of legacy VFD cabinet 99 has an opening sized for a legacy keypad 14. Within the opening is mounted a legacy keypad assembly 20 that includes the legacy keypad 14 and a legacy keypad mounting 10. In the upgraded state, door 101 of upgraded VFD cabinet 100 is the same cabinet door 101 that was used in the legacy state. Cabinet door still has the preexisting opening (shown as opening 701 in FIG. 7E). Mounted to cabinet door 101 is an upgraded keypad assembly 120 that includes an upgraded keypad 114 and an upgraded keypad mounting assembly having an upgraded faceplate 110 and an adapter 112. Upgraded keypad 114 has a different size (including footprint) than legacy keypad 14.

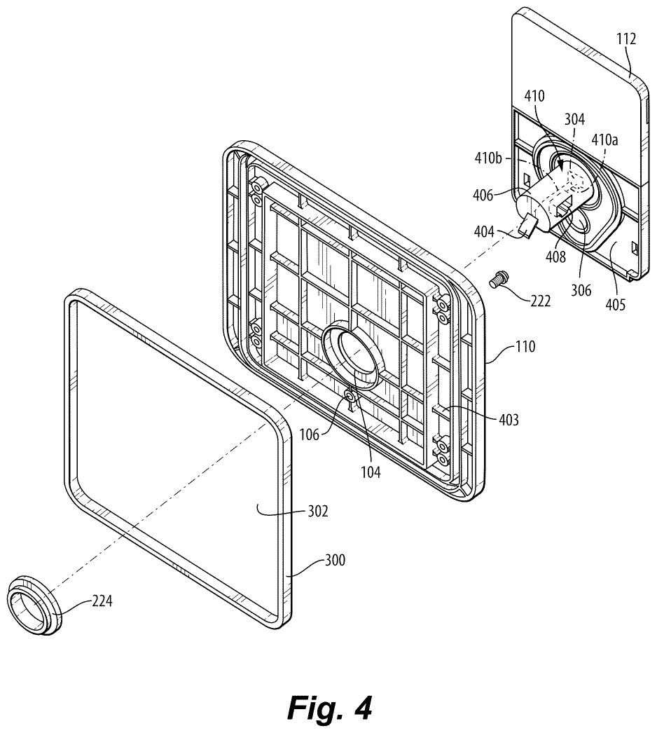

Legacy VFD cabinet 99 can be retrofitted to provide upgraded VFD cabinet 100. However, the retrofit process may call for changing the entire door 101 of legacy VFD cabinet 99 with a replacement door due to mismatches in size and connection criteria between legacy keypad 14 and upgraded keypad 114. The replacement door would need to accommodate a footprint of upgraded keypad 114 (which is different than a footprint of legacy faceplate 10 and keypad 14). Additionally, an aperture would need to be drilled into the replacement door to accommodate electrical conductor portion 406 (shown in FIG. 4). Accommodating the footprint of upgraded keypad 114 and providing the aperture for its electrical connections could require replacing door 101 with a new door. However, production of such a new door would consume raw materials, energy, and manpower, and incur financial costs. The door 101 would be scrapped, either to be recycled (which also consumes energy, manpower and financial resources) or perhaps added to unrecycled material that pollutes our planet.

Alternatively, providing the hole in door 101 could require shutting down upgraded VFD cabinet 100, removing the door 101, drilling a hole in door 101 to provide the aperture, and replacing door 101. This requires time, manual labor, causes downtime of upgraded VFD cabinet 100, which in turn causes downtime of the motor(s) driven by VFD cabinet 100 and any systems using the motor(s).

Disclosed is a method and an assembly that accommodates the footprint of upgraded keypad 114 and its electrical connections. The disclosed method and assembly streamline the replacement process and avoids any need to remove or replace door 101, perform drilling in door 101, or shut down VFD cabinet 100 (and the motor(s) (not shown) that are driven by VFD cabinet 100 and any system(s) (not shown) using the motor(s)) when installing upgraded keypad 114.

Legacy VFD cabinet 99 includes one or more legacy VFDs 30 and one or more legacy computer components 32. Upgraded VFD cabinet 100 includes one or more upgraded VFDs 130 and/or one or more upgraded computer component 132. Additionally, upgraded VFD cabinet 100 can include one or more legacy VFDs 30 and one or more legacy computer components 32.

With reference to FIG. 2, a keypad mounting kit 200 is provided, including a mounting structure, such as faceplate kit 202, and an adapter kit 204. Faceplate kit 202 includes faceplate 110 and multiple fasteners 220 for semi-permanently affixing faceplate 110 to cabinet door 101. Semi-permanent affixing components can include removably attaching the components, (e.g. with a screw, via a pressure connection, etc.), such that the components could be disassembled without damage. Semi-permanent affixing can also include an attachment that could be permanent but may be not intended necessarily to be permanent. Disassembly of the components could possibly cause some damage to the components being mated (e.g., by riveting). The semi-permanent affixation could also fade or erode away over time.

In certain embodiments, fasteners 220 can be, for example screws, nuts and bolts, studs, staples, clips, hooks, adhesive, latches, etc. that can cooperate with a structure in cabinet door 101 (referred to as cooperating fastener structures 22 and shown as an example in FIG. 7E as holes) to mount faceplate 110 to door 101. In certain embodiments, cooperating fastener structures 22 can be holes, loops, grommets, latch plates, etc. In certain embodiments, faceplate 110 can alternatively a cover, panel, overlay, bezel, etc. The fasteners 220 and cooperating fastener structures 22 can be reversed, such that cooperating fastener structures are provided with faceplate kit 202 (e.g., as holes, loops, etc., on faceplate 110) and can cooperate with a fastener (e.g., screw, hook, etc. provided on cabinet door 101).

Adapter kit 204 includes adapter 112, at least one alignment insert 222 (e.g., pin, rods, etc.), cap ring 224, and adapter cap 226. Adapter kit 204 can be assembled with upgraded keypad 114 and then assembled with faceplate kit 202. In certain embodiments, faceplate 110 is provided with connector aperture 104 and alignment aperture 106, one or both of which can be a through hole. Connector aperture 104 includes a through hole or cavity through which an electrical connector (e.g., electrical conductor portion 406, shown in FIG. 4) of adapter 112 can be inserted. Alignment aperture 106 can be a through hole or cavity through which alignment insert 222 can be inserted, without limitation to a hole and pin for alignment. Assembly of keypad mounting kit 200, faceplate kit 202, and adapter kit 204 is further described below.

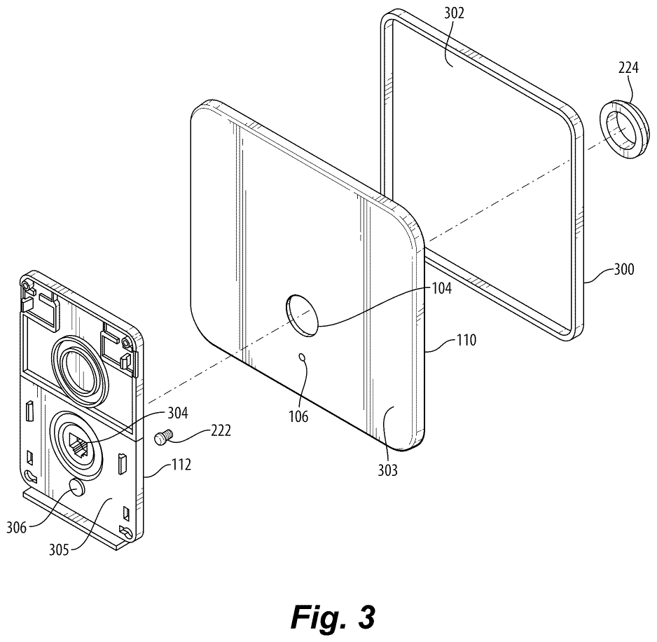

With reference to FIGS. 3 and 4, respective front-and back-perspective exploded views are provided of adapter 112, upgraded faceplate 110, and gasket 300. Faceplate 110 is shown to have a front face 303 and a back face 403. Adapter 112 has a front face 305 and a back face 405.

When adapter 112 is mounted on faceplate 110, back face 405 of adapter 112 can lay flat against front face 303 of faceplate 110. Upgraded keypad 114, when mounted on adapter 112, can lay flat against adapter 112's front face 305. Electrical conductor portion 406 extends from adapter 112's back face 405. When adapter 112 is mounted on faceplate 110, electrical conductor portion 406 extends through aperture 104 of faceplate 110.

The respective front and back exploded perspective view shown in FIGS. 3 and 4 show that adapter 112 is aligned with faceplate 110. In one or more embodiments, this alignment can be achieved by insertion of alignment insert 222 through an alignment aperture 306 of adapter 112 and through alignment aperture 106 of faceplate 110. Once skilled in the art will appreciate that other methods and structures for alignment can be used. Other examples of alignment structures and methods for alignment of adapter 112 and faceplate 110 include cooperating guides and guide rails, dowel pins with slip fit, alignment bullets, etc.

FIG. 3 further shows adapter 112 having an adapter port 304 that is accessible and exposed on its front face 305. With additional reference to FIG. 4, an electrical conductor portion 406 of adapter 112 extends from adapter 112's back face 405. An adapter conductor 410 extends through electrical conductor portion 406. Adapter 410 is an electrical conductor formed of an electrically conductive material that has opposing first and second ends and is housed in an at least partially hollow, insulative conductor housing 412 of electrical conductor portion 406. Adapter conductor 410 connects at its first end to a conductive portion of adaptor port 304 that is exposed on adapter 112's front face 305, Adapter conductor 410 can include one or more electrical conductors. A first electrical conductor transfers signals to and/or from updated keypad 114 when coupled to adapter port 304. A second electrical conductor can connect to a ground connector of adapter port 304. The first electrical conductor couples to a conductor port 408 provided on an outer surface of conductor housing 412 and is accessible by a conductor, such as first end terminal 704 of communication cable 702 shown in FIG. 7. The second conductor terminates at ground conductor 404. Ground conductor 404 extends through and exits conductor housing 412.

A communicative coupling is established by the first conductor for an exchange of signals between upgraded keypad 114 and conductor port 408, with a ground connection available via ground conductor 404. When communication cable 702 is connected to conductor port 408, an exchange of signals between upgraded keypad 114 and computer components 132 of VFD cabinet is facilitated. Exchanging signals refers to a unidirectional or bidirectional exchange. Conductor port 304 and adapter conductor 410 are in bidirectional or unidirectional electrical communication with one another such that any signals that are received by adapter port 304 can be received by adapter conductor 410 via the electrical communication, and/or any signals that are received by adapter conductor 410 can be received by adapter port 304 via the electrical communication.

Conductor housing 412 is formed using a nonconductive material and is electrically isolated from adapter conductor 410. Conductor housing 412 insulates adapter conductor 410 and its interior provides a protective area or cavity that protects and conceals adapter conductor 410 and the coupling between adaptive port 304 and adapter conductor 410 by closing access of the coupling to an ambient environment of adapter 112.

Cap ring 224 can be assembled with electrical conductor portion 406 and cover and/or seal connector aperture 104 of faceplate 110 when electrical conductor portion 406 extends through connector aperture 104. In certain embodiments, cap ring 224 can function to provide a seal about connector aperture 104 once faceplate 110 and adapter 112 are assembled to prevent ingress of contaminants through connector aperture 104 into VFD cabinet 100.

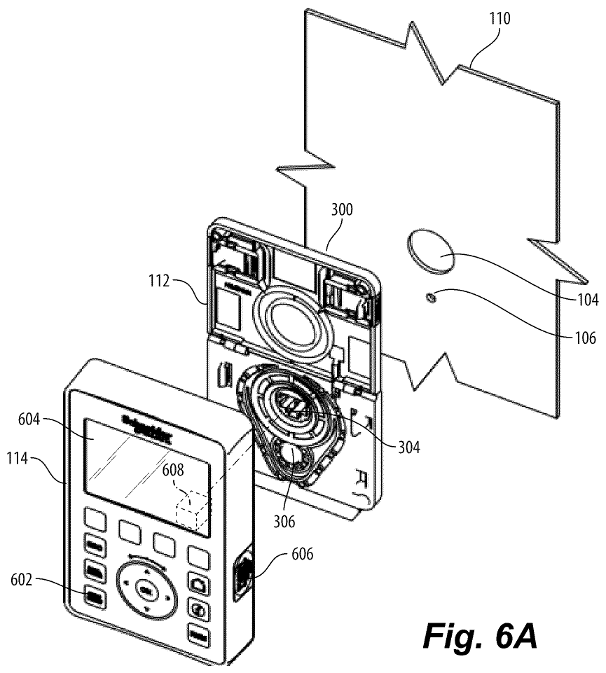

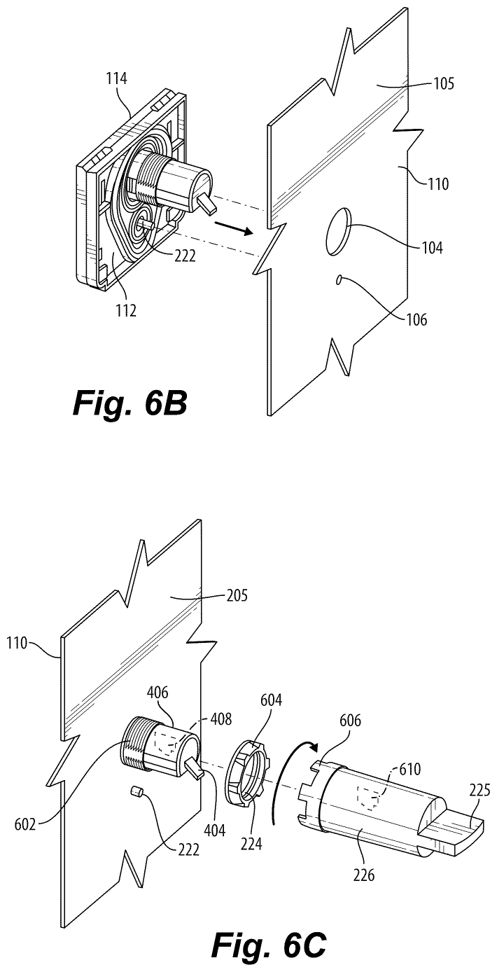

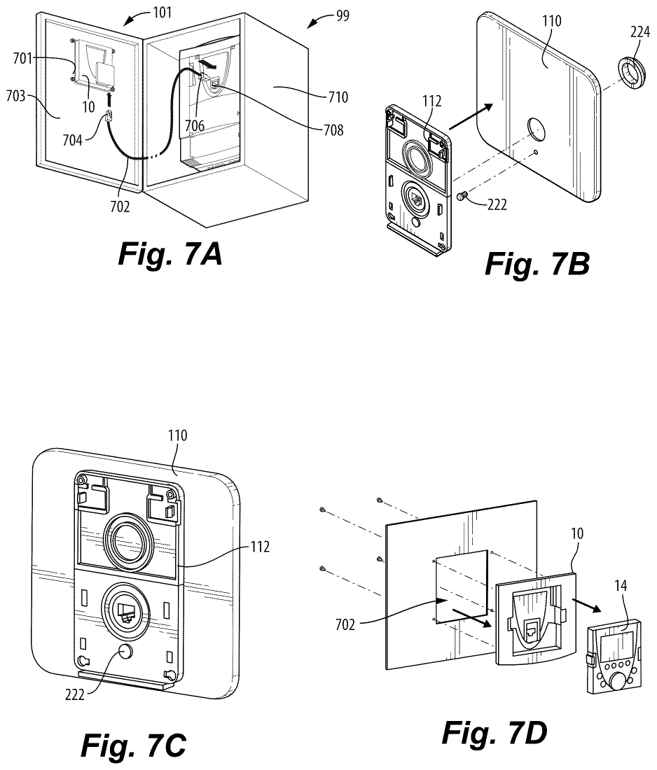

In certain embodiments, as can be seen in FIG. 6B, conductor housing 412 can have a cooperative fastening structure on its outer surface that cooperates with cap ring 224 for securing cap ring 224 to it and to adaptor 112. Cap ring 224 can contribute to securing adapter 112 to faceplate 110 by limiting movement of adapter 112 once cap ring 224 is fastened onto conductor housing 412 that extends beyond backside 205 of faceplate 110.

Adapter 112 is semi-permanently affixed to faceplate 110. In certain embodiments this affixation can be permanent. The affixation is accomplished at least by engaging aligning structure 222 with aperture 106 of faceplate 110. The affixation is further secured once upgraded keypad 114 and adapter cap 226 are assembled, e.g., using cap ring 224, as shown and described with respect to FIG. 6C.

In some embodiments a gasket 300 is provided, having a frame shape that frames an open area 302. Gasket 300 can fit on faceplate 110 like a frame. Gasket 300 can further interface with door 101 to provide a seal that prevents contaminants from entering VFD cabinet 100 via the preexisting opening (shown as opening 701 in FIG. 7E) in door 101 that receives upgraded keypad assembly 120. Gasket 300 can be formed of a flexible material, such as rubber. Other materials that can be used are metal, cork, paper, without limitation.

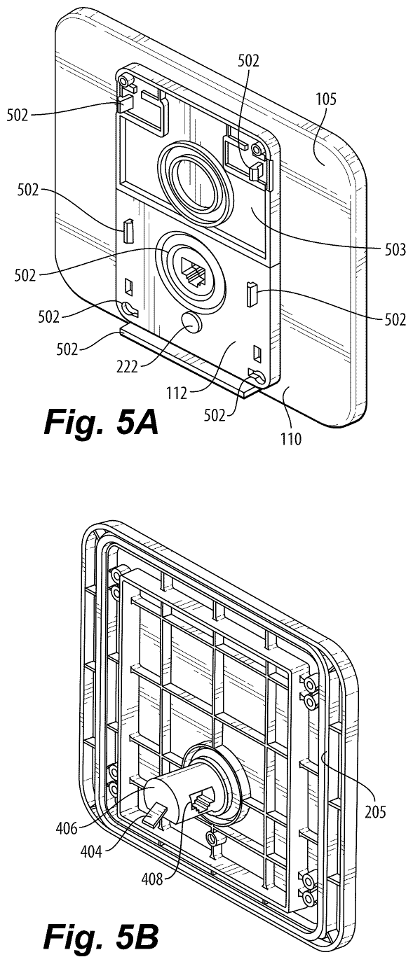

FIGS. 5A and 5B show respective front and back perspective views of faceplate 110 and adapter 112 assembled together, with back face 405 of adapter 112 abutting front face 303 of faceplate 110. Alignment insert 122 is shown inserted through alignment apertures 106 and 306. Adapter port 304 is exposed at front face 305 of adapter 112, and the second end of electrical conductor 410 is exposed via conductor port 408 and ground conductor 404 behind back face 405 of faceplate 110.

FIG. 5A shows multiple structural features 502 of adapter's front face 503 that can provide physical support and/or semi-permanent affixation of upgraded keypad 114 to adapter 112. Some nonlimiting examples of structural features 502 can be a support at a bottom of adapter 112 that can hold weight, a cradle, male structure (e.g., a notch, pin, bracket, etc.) that a can be inserted into, engage with, and/or lock with a mating female structure provided on the back of upgraded keypad 114, a mating female structure that can receive, engage with, and/or lock with a male structure (e.g., a notch, pin, bracket, etc.) provided on the back of upgraded keypad 114.

With reference to FIGS. 6A-6C, various views are shown of upgraded keypad assembly 120. FIG. 6A shows an exploded front perspective view of faceplate 110, adapter 112, and upgraded keypad 114. In certain embodiments, upgraded keypad 114 includes a user interface having input devices 602 (e.g., touch or mechanical keys and/or dials, a touch screen, etc.), and/or a display 604. The user interface allows a user to interact via the keypad with computer components 132 of VFD cabinet 100 (see FIG. 1). In certain embodiments, upgraded keypad includes a port 606 that can be used as an interface with one or more external devices (not shown), which facilitates interaction between the external device(s) and the computer components 132 of VFD cabinet 100. It is understood that upgraded keypad 114 includes a keypad electrical interface 608 that couples with adapter port 304 for establishing a communicative coupling for an exchange of signals between adapter 112 and upgraded keypad 114.

Securing of upgraded keypad 114 to adaptor 112 can use a latch, snap fit and/or other physical fastening structure that provides physical connection and support. The fastening structure(s) used can include a release structure that allows an operator to remove the keypad 114 from the adaptor 112. Depending on the fastening and release structures used, the keypad 114 can be removed form adaptor 112 with or without tools.

Additionally, or alternatively, the keypad electrical interface 608 is electrically coupled with adapter port 304, e.g., via a plug-in and/or snap fit connection. This electrical coupling can further provide physical connection and/or physical support of upgraded keypad 114 on adapter 112. Other structures can be used to assure the electrical connection is provided between the keypad electrical interface 608 and adapter port 304 and that upgraded keypad 114 is fixed and well secured to adapter 112. The structures for physical and/or electrical affixation (e.g., structural features 502 shown in FIG. 5A and/or port 304 shown in FIG. 3) can allow for an easy mounting of upgraded keypad 114 to adapter 112, e.g., that can be performed tool-free.

FIG. 6B shows an exploded rear-perspective view in which upgraded keypad 114 is assembled with adapter 112 and is aligned with faceplate 110 (e.g., via alignment insert 222). and electrical conductor portion 406 is inserted through connector aperture 104 of faceplate 110.

FIG. 6C shows an exploded rear-perspective view of faceplate 110 assembled with the assembly of upgraded keypad 114 and adapter 112, which are aligned with cap ring 224 and adapter cap 226 for assembly. Electrical conductor portion 406 extends through a cavity defined by adapter cap 226. Rotation of cap ring 224 (e.g., as shown by the rotational arrow) can physically couple cap ring 224 to a threaded section 602 of conductor housing 412. Cap ring 224 is further configured to couple with adapter cap 226. Adapter cap 226 is provided with an access area, cap access 610. When adapter cap 226 is assembled with electrical conductor portion 406, cap access 610 is aligned with conductor port 408 to allow access to conductor port 408, e.g., by first terminal end 704 of communication cable 702 shown in FIG. 7.

For example, and without limitation, cap ring 224 and adapter cap 226 can have cooperating structures that couple together, such as indentations 604 of cap ring 224 and teeth 606 of adapter cap 226. The cooperating structures of cap ring 224 and adapter cap 226 can lock in place (temporarily or permanently) to secure the coupling. In certain embodiments, the coupling and locking of the cooperating structures of cap ring 224 and adapter cap 226 can be facilitated by the same rotation used to secure cap ring 224 to conductor housing 412.

In certain embodiments, once cap ring 224 is engaged with adapter cap 226 and adapter 112 via conductor housing, the cavity defined by adapter cap 226 is a protected area that is totally enclosed. This provides protection to the electronic conductors and couplings within the cavity, such as from contaminants and tampering (e.g., unwanted tampering).

Once electrical conductor portion 406 are assembled with adapter cap 226, the second end of the second conductor (the ground conductor) of electrical conductor 410 communicatively communicates with an internal end of cap ground conductor 225 from inside adapter cap 226. Cap ground conductor 225 is exposed on an external face of adapter cap 226 for facilitating access to a ground cable, such as ground cable 720 shown in FIGS. 7G and 7H. This facilitates ground connectivity between upgraded keypad 114 and a ground connection (not shown)of VFD cabinet 100.

Cap ground conductor 225 can be configured with a male connector, as shown in FIGS. 2 and 6B, or with a female connector, as shown in FIGS. 7F-7H.

It is noted that assembly of faceplate 110, adapter 112, upgraded keypad 114, adapter cap 226, and cap ring 224 can be performed at a location other than the field where legacy cabinet 99 is located and upgraded.

With reference to FIGS. 7A-7H, a series of operations is shown for upgrading legacy VFD cabinet 99 to VFD cabinet 100 with provision of upgraded keypad 114. It is noted that the order of operations shown in FIGS. 7A-7H is not required, so in principle, the various operations may be performed out of the illustrated order. Also, certain operations may be skipped, different operations may be added or substituted, some operations may be performed in parallel instead of strictly sequentially, or selected operations or groups of operations may be performed in a separate procedure following the embodiments described herein.

FIG. 7A shows legacy VFD cabinet 99 in its legacy state with door 101 of cabinet 706 open, allowing a view of an interior of legacy VFD cabinet 99 and its communication port 708 for connecting with legacy keypad 10. A back side 703 of door 101 is visible when door 101 in an open position. Also in view is a communication cable 702 having a first end terminal 704 for connection with conductor port 408 for communicative coupling with legacy keypad 10. Communication cable 702 also has a second end terminal 706 for connection with communication port 708 of VFD cabinet 99 provided in an interior 710 of legacy VFD cabinet 99 for a communicative coupling with computer components of legacy VFD cabinet 99. Communication cable 702 can be a standard or proprietary cable, such as a registered jack 45 (RJ45), and communication port 708 is configured to operably connect with second end terminal 706 of communication cable 702. Signals can be exchanged between legacy keypad 14 and computer components (not shown) of legacy VFD cabinet 99 via communication cable 702.

FIG. 7B is an exploded front perspective view, having an arrow that indicates assembly of adapter 112 with faceplate 110. Alignment insert 222 can be used for alignment of adapter 112 with faceplate 110, and cap 226 can be used to secure the adapter 112 to faceplate 110 and seal connector aperture 104. Gasket 300 (shown in FIG. 3) can optionally be included. The description of FIG. 3 is applied to FIG. 7B and is not repeated for purposes of brevity.

FIG. 7C is a front perspective view of adapter 112 once it is assembled with faceplate 112 and ready to be mounted to door 101. The description of FIG. 5 is applied to FIG. 7C and is not repeated for purposes of brevity.

FIG. 7D is an exploded front perspective view of legacy VFD cabinet 99 in which legacy faceplate 10 and legacy keypad 14 are removed in preparation of retrofitting legacy VFD cabinet 99 with an upgraded keypad 114, such that legacy VFD cabinet 99 can be upgraded to be upgraded VFD cabinet 100. Removal of legacy faceplate 10 and legacy keypad 14 can include disconnection of communication cable 702 (not shown in FIG. 7D, but shown in FIG. 7A) from legacy keypad 14. The other end of communication cable 702 can remain connected to communication port 708 of VFD cabinet 99. In some embodiments, the connection between communication cable and 702 is required to remain intact. In some embodiments cable 702 can be disconnected from cabinet 99. It is noted that the same communication cable 702 can be used for connecting to both legacy keypad 14 and upgraded keypad 114 via adapter 112. Removal of legacy faceplate 10 and legacy keypad 14 can further include removal of legacy fasteners 24 from cooperating fastener structures 22 to allow legacy faceplate 10 to be removed from door 101. The arrows indicate removal of legacy faceplate 10 and legacy keypad 14 from door 101.

FIG. 7E is an exploded front perspective view of assembled adapter 112 and faceplate 110 being mounted (as indicated by the arrows) to door 101 for covering, and preferably sealing, preexisting opening 701 of door 101. Mounting assembled faceplate 110 and adapter 112 to door 101 can include engaging fasteners 220 and cooperating fastener structures 22 that are configured for semi-permanently affixing faceplate 110 (in certain embodiments with adapter 112) to cabinet door 101. In the example shown, fasteners 220 are inserted through cooperating fastener structures 22 for securing to cooperating structures on back face 405. Fasteners 220 and/or cooperating fastener structures 22 can be preexisting fasteners (e.g., legacy fasteners 24 and cooperating fastener structures 22).

Upgraded keypad 114 is mounted to adaptor 112. The description of FIG. 6A is applied to FIG. 7E and is not repeated for purposes of brevity. The order of mounting adapter 112 to upgraded faceplate 112, mounting upgraded faceplate 112 to door 101, and mounting upgraded keypad 114 to adapter 112 is illustrative and is not intended to be limiting. Certain advantages can be gained by the order shown, but in certain embodiments, this does not preclude using a different order.

FIG. 7F is a back perspective view of door 101 with upgraded faceplate 110, adapter 112, and upgraded keypad 114 mounted to door 101. Adapter cap 226 is assembled with adapter 114, e.g., using cap ring 224, as shown and described with respect to FIG. 6C, providing a physical coupling of adapter cap 226 to adapter 114. The description of FIG. 6C is applied to FIG. 7F and is not repeated for purposes of brevity. Backside 205 of adapter 112 is exposed through opening 701 of door 101. Electrical conductor portion 406 protrudes through connector aperture 104 and opening 701 of door 101. Electrical conductor portion 406 is not visible since it is covered by adapter cap 226. Adapter cap 226 provides access to conductor port 408 of electrical portion 406 via cap access 610, e.g., for connection with communication cable 702 (shown in FIGS. 7G and 7H). Adapter cap 226 further provides access to the ground conductor of electrical conductor 410 via cap ground conductor 225, e.g., for connection with ground cable 720 (shown in FIGS. 7G and 7H).

FIG. 7G shows communication cable 702 in which its first end terminal 704 is ready to be (but is not yet) connected to adapter 112, e.g., conductor port 408 via cap access 610), and therefore is not yet connected to keypad electrical interface 608 of upgraded keypad 114. Second end terminal 706 is ready to be connected with communication port 708 provided in interior 710 of upgraded VFD cabinet 100. FIG. 7G also shows ground cable 720 in which its first end terminal 722 is ready to be (but is not yet) connected to cap ground connection 225 (which couples with the ground conductor of electrical conductor 410 and to a ground of keypad electrical interface 608). A second end terminal 724 of ground cable 720 may be permanently or temporarily connected to or disconnected from a ground terminal 730 of upgraded VFD cabinet 100

FIG. 7H is a perspective front view of couplings established with upgraded VFD cabinet 100. Adapter cap 226 is shown secured by cap ring 224. First terminal end 704 of communication cable 702 is shown connected via cap access 608 to conductor port 408 for establishing a communicative coupling with upgraded keypad 114. In one or more embodiments, first terminal end 704 can use a standard RJ45 connection or another standard or proprietary type of connection, as would be known to one skilled in the art. This connection facilitates communication (meaning for exchanging signals) between upgraded keypad 114 and computer components 132 of VFD cabinet 100. First terminal end 722 of ground cable 702 is shown connected with cap ground connection 225 for establishing a grounding connection with upgraded keypad 114. In certain embodiments, first terminal end 722 is configured to mate with cap ground connection 225, ground cable 702, e.g., using standard or proprietary connections.

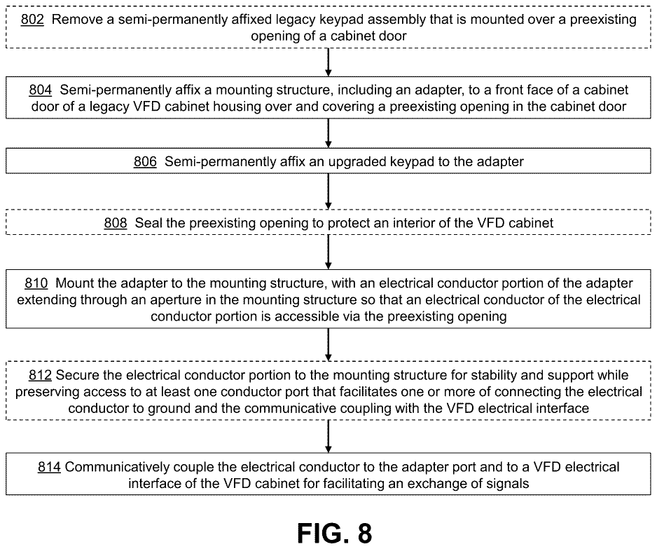

With reference now to FIG. 8, shown is/are flowchart(s) demonstrating implementation of the various exemplary embodiments. The flowchart(s) in FIG. 8 are performed when assembling an upgraded keypad (such as upgraded keypad 114 shown in FIG. 1) on a legacy cabinet door (such as cabinet door 101 shown in FIG. having preexisting opening 701 shown in FIG. 7D and FIG. 7E). It is noted that the order of certain operations shown in FIG. 8 is not required, so in principle, the certain operations may be performed out of the illustrated order. Also, certain operations may be skipped, and different operations may be added or substituted.

With reference to FIG. 8 an example method 800 is shown for assembling an upgraded keypad (e.g., upgraded keypad 120 shown in FIG. 1) on the legacy cabinet door (e.g., cabinet door 101 shown in FIG. 1). The method begins at block 802. At block 802, a semi-permanently affixed legacy keypad assembly (e.g., legacy keypad 20 shown in FIG. 1) mounted over a preexisting opening of a cabinet door (e.g., preexisting opening 701 of cabinet door 101 shown in FIGS. 7D and 7E) is removed from the cabinet door. The cabinet door is a door to a VFD cabinet (e.g., VFD cabinet 100 shown in FIG. 1) that houses one or more VFDs (e.g., VFDs 130 shown in FIG. 1). The preexisting opening is sized for the legacy keypad. As indicated by the dotted lines, block 802 is optional. For example, the method can begin using a cabinet door and VFD cabinet from which a legacy keypad assembly was previously removed.

At block 804, a mounting structure (e.g., faceplate 110 shown in FIG. 1) together with an adapter (e.g., adapter 112 shown in FIG. 1) is semi-permanently affixed to a front face of the cabinet door over and covering the preexisting opening in the cabinet door. The adapter can be configured (e.g., physically shaped) to support and hold an upgraded keypad having a different size than the legacy keypad.

For example, in one or more embodiments, the adapter can include one or more physical structures, such as structural features 502 shown in FIG. 5, for semi-permanently affixing the upgraded keypad to the adapter. The adapter can be semi-permanently affixed to the mounting structure before or after mounting the mounting structure to the cabinet door.

At block 806, the upgraded keypad is semi-permanently affixed to the adapter. A keypad electrical interface (e.g., keypad connector 608 shown in phantom in FIG. 6A) of the upgraded keypad is physically and communicatively coupled to an electrical port (e.g., adapter port 304 shown in FIG. 6A) of the physical adapter. The communicative coupling facilitates an exchange of signals.

At optional block 808, the preexisting opening is sealed to protect an interior of the VFD cabinet. In one or more embodiments, the seal can be established by installing a gasket (e.g., gasket 300 shown in FIG. 3) between the mounting structure and the edges of the preexisting opening in the cabinet door. The gasket can seal the preexisting opening to prevent contaminants from entering the VFD cabinet via the preexisting opening.

At block 810, the adapter is inserted in the mounting structure, with an electrical conductor portion of the adapter extending through an aperture in the mounting structure (e.g., aperture 104 shown in FIG. 1) and the preexisting opening in the cabinet door. In this way, one or more electrical conductors (e.g., electrical conductors 410a and 410b shown in FIG. 4) of the electrical conductor portion is accessible via the preexisting opening (e.g., via conductor port 408 and ground conductor 404).

In one or more embodiments, the electrical conductor portion is physically coupled to the mounting structure by one or more fastening means. While insertion of the electrical conductor portion through the aperture provides a degree of support and stability, the amount of support and/or stability may be inadequate for some applications. The support and stability are increased by using a ring, clamp, clip, or the like, that can fasten the electrical conductor portion to the mounting structure. In one or more embodiments, the ring (such as cap ring 224 shown in FIG. 2) and electrical conductor portion can have cooperating features (for example without limitation, mating structures, grooves and screw threads, etc.). A back face of the portion of the adapter that is supporting the keypad (the keypad being supported on its front face) is pressed against a front face of the mounting structure while the fastening means is coupled to the electrical connector portion extending past the back face of the mounting structure while it is moved, tightened, or clamped to press on the back face of the mounting structure. This causes the adapter to be squeezed against opposite faces the mounting structure, providing support and stability.

At optional block 812, in one or more embodiments, an adapter cap is placed over the portion of the electrical conductor that extends through the aperture in the mounting structure. The adapter cap can provide physical protection and/or support for the adapter when it is inserted in the mounting structure. For example, the adapter cap can cooperate with the cap ring or other fastening structure to help provide physical support and/or a sealed environment for the electrical conductor portion.

The adapter cap can provide access to and a ground connection with the electrical conductor(s), (e.g., by providing access to conductor port 408 via cap access 610 and by communicatively couples a cap ground connection 225 to ground conductor 404).

At block 814, a communication cable (such as communication cable 702 shown in FIGS. 7G and 7H) is communicatively coupled and one end to the electrical conductor and the updated keypad's electrical interface via conductor port (e.g., via the cap access). The communication cable is coupled at another end to a VFD electrical interface of the VFD cabinet (e.g., communication port 708 shown in FIG. 7G) for facilitating an exchange of signals. Additionally, a ground cable (e.g., ground cable 720 shown in FIGS. 7G and 7H) can be electrically coupled at a first end to a grounding portion of the electrical conductor and the updated keypad's electrical interface via ground conductor 404 (e.g., via the cap ground connection 225). The ground cable can be electrically coupled at another end to a ground terminal (e., ground terminal 730) of the VFD cabinet. A communicative coupling and ground coupling thus can be established between the upgraded keypad and the computer component(s) of the VFD cabinet.

In one or more embodiments, the communicative coupling of the electrical conductor and the adapter port is protected by at least a housing of the electrical conductor portion from an ambient environment of the adapter.

In one or more embodiments, the communicative coupling of the electrical adapter to the electrical port is performed inside a protected area (e.g., an interior of conductor portion and/or covered by physical structures of the adapter or the upgraded keypad, and/or an interior defined by at least a housing of the electrical conductor portion, and the communicative coupling of the electrical conductor to the VFD electrical interface for exchanging signals is performed outside the protected area. In this way, the coupling between the adaptive port 304 and the electrical conductor are protected by closing access of the coupling to an ambient environment of adapter.

In one or more embodiments, a first end of the electrical conductor exits the insulative housing for communicatively coupling with the adapter port and a second end of the electrical conductor exits the insulative housing at a conductor port that is configured to receive a connector coupled to the VFD electrical interface for facilitating the communicative coupling with the VFD electrical interface.

In one or more embodiments, the protected area can be defined by an adapter cap, such as adapter cap 226 shown in FIG. 2. The adapter cap can be placed over and enclose the housing of the electrical conductor portion and provide access to the conductor port.

In one or more embodiments, the protected area can be sealed by a sealing structure, such as cap ring 222 shown in FIG. 2. The sealing structure can seal an interface between the insulative housing the mounting structure.

In one or more embodiments, a first sealing structure and an outer surface of the electrical conductor portion have first cooperative fastening structures configured to be fastened to each other for securing the first sealing structure to the electrical conductor portion when the electrical conductor portion extends through the aperture in the mounting structure, wherein fastening the cooperative fastening structures enhances the affixation of the adapter to the mounting structure, and/or

In one or more embodiments, the first sealing structure and the adapter have second cooperative fastening structures configured to be fastened to each other for securing the adapter to the first sealing structure.

In one or more embodiments, a second sealing structure is configured to be disposed between the mounting structure and the preexisting opening in the cabinet door when the mounting structure is positioned to cover the preexisting opening in the cabinet door, and the second sealing structure is further configured to seal the preexisting opening to protect an interior of the VFD cabinet.

In one or more embodiments, the mounting structure and the adapter further include cooperating alignment structures to facilitate alignment of the adapter and the mounting structure. Nonlimiting examples of the alignment structures include alignment insert 222 and alignment aperture 306 shown in FIG. 3.

In one or more embodiments, when the protected area defined by at least the housing of the electrical conductor portion is sealed by the first sealing structure, the protected area is totally enclosed.

In one or more embodiments, the legacy keypad assembly was affixed to the cabinet door using one or more first legacy fastening structures engaged with one or more legacy cooperating fastening structures provided with cabinet door. In one or more embodiments, affixing the mounting structure to the cabinet door includes cooperatively engaging the one or more first legacy fastening structures with the one or more legacy cooperating fastening structures provided with cabinet door. In one or more embodiments, affixing the keypad to the keypad adapter assembly is a tool-free process.

Potential advantages of the disclosed method and keypad adapter assembly include the ability to upgrade a VFD cabinet from a legacy state that uses a legacy keypad to an upgraded state that uses an upgraded keypad. Even when the upgraded keypad has a different footprint than legacy keypad, the same cabinet door can still be used. This holds true even when the cabinet door has an opening to accommodate the footprint of the legacy keypad. The disclosed method and keypad adapter assembly makes it possible to perform the upgrade without removing, altering, or replacing the VFD cabinet door, either of which would involve downtime of the VFD(s) housed in the cabinet and downtime of all motor(s) controlled by the VFD(s). Furthermore, assembly steps that need to be performed in the field where the legacy VFD cabinet is located are simple and limited. These steps do not require more skill than disengaging fasteners, engaging fasteners, and connecting a cable. The fasteners can be screws that engaged and disengaged by screwing them in and out. The cable can have a standard or proprietary terminal end that simply snaps into the appropriate port.

It is to be understood that the above description is intended to be illustrative and is not restrictive. Many other implementation examples are apparent upon reading and understanding the above description. Although the disclosure describes specific examples, it is recognized that the systems and methods of the disclosure are not limited to the examples described herein but may be practiced with modifications within the scope of the appended claims. Accordingly, the specification and drawings are to be regarded in an illustrative sense rather than a restrictive sense. The scope of the disclosure should, therefore, be determined with reference to the appended claims, along with the full scope of equivalents to which such claims are entitled.

It is understood that embodiments of the disclosure herein may be configured as a system, method, or combination thereof.

It is to be appreciated that the concepts, systems, circuits, and techniques sought to be protected herein are not limited to use in the example applications described herein (e.g., industrial applications), but rather may be useful in substantially any application where it is desired to receive decision support for each step in an automated fashion.

Having described various embodiments, which serve to illustrate various concepts, structures and techniques that are the subject of this patent, it will now become apparent to those of ordinary skill in the art that other embodiments incorporating these concepts, structures and techniques may be used. Additionally, elements of different embodiments described herein may be combined to form other embodiments not specifically set forth above.

1. A keypad adapter assembly comprising:
a mounting structure configured to be semi-permanently affixed to a front face of a cabinet door of a variable frequency drive (VFD) cabinet housing one or more VFDs and to cover a preexisting opening in the cabinet door, the preexisting opening being sized for a legacy keypad;
an adapter having a front face that is configured to support and hold an upgraded keypad having a different size than the legacy keypad, the adapter being configured to be permanently or semi-permanently affixed to the mounting structure; and
an adaptor port that mates with a keypad electrical interface of the upgraded keypad for establishing a communicative coupling for exchanging signals between the adaptor port and the keypad electrical interface,
wherein the adapter includes an electrical conductor portion having an electrical conductor configured to communicatively couple the adaptor port to a VFD electrical interface of the VFD cabinet for exchanging signals.

2. The keypad adapter assembly of claim 1, wherein the communicative coupling of the electrical conductor and the adapter port is performed inside a protected area defined by at least a housing of the electrical conductor portion and the communicative coupling of the electrical conductor and the VFD electrical interface is performed outside the protected area.

3. The keypad adapter assembly of claim 2, wherein the electrical conductor portion includes an insulative housing that houses the electrical conductor, a first end of the electrical conductor exiting the insulative housing for communicatively coupling with the adapter port and a second end of the electrical conductor exiting the insulative housing at a conductor port that is configured to receive a connector coupled to the VFD electrical interface for facilitating the communicative coupling with the VFD electrical interface.

4. The keypad adapter assembly of claim 3, further comprising an adaptive cap that encloses the insulative housing and provides access to the conductor port.

5. The keypad adapter assembly of claim 4, further comprising a first sealing structure configured to seal an interface between the insulative housing the mounting structure to prevent entry of contaminants or tampering into the protected area.

6. The keypad adapter assembly of claim 3, further comprising a first sealing structure,
wherein the first sealing structure and an outer surface of the electrical conductor portion have first cooperative fastening structures configured to be fastened to each other for securing the first sealing structure to the electrical conductor portion when the electrical conductor portion extends through the aperture in the mounting structure, wherein fastening the cooperative fastening structures enhances the affixation of the adapter to the mounting structure, and/or
wherein the first sealing structure and the adapter have second cooperative fastening structures configured to be fastened to each other for securing the adapter to the first sealing structure.

7. The keypad adapter assembly of claim 1, wherein the mounting structure and the adapter further include cooperating alignment structures to facilitate alignment of the adapter and the mounting structure.

8. The keypad adapter assembly of claim 1, further comprising a second sealing structure configured to be disposed between the mounting structure and the preexisting opening in the cabinet door when the mounting structure is positioned to cover the preexisting opening in the cabinet door, and the second sealing structure is further configured to seal the preexisting opening to protect an interior of the VFD cabinet.

9. The keypad adapter assembly of claim 1, wherein the adapter includes one or more physical structures for semi-permanently affixing the upgraded keypad to the adapter.

10. The keypad adapter assembly of claim 9, wherein the adapter is configured for tool-free affixation of the of the upgraded keypad to the physical adapter and/or the adapter port is configured for tool-free mating with the keypad electrical interface.

11. The keypad adapter assembly of claim 5, wherein when sealed by the first sealing structure, the protected area defined by at least the housing of the electrical conductor portion is totally enclosed.

12. The keypad adapter assembly of claim 1,
wherein prior to affixing the mounting structure to the cabinet door, a legacy keypad assembly semi-permanently affixed to the cabinet door is removed, wherein the legacy keypad assembly was affixed to the cabinet door using one or more first legacy fastening structures engaged with one or more legacy cooperating fastening structures provided with cabinet door,
wherein the keypad adapter assembly further comprises the one or more first legacy fastening structures, and
wherein affixing the mounting structure to the cabinet door includes cooperatively engaging the one or more first legacy fastening structures with the one or more legacy cooperating fastening structures provided with cabinet door.

13. A method comprising:
semi-permanently affixing a mounting structure with an adapter to a front face of a cabinet door of a VFD cabinet housing one or more VFDs, including affixing the mounting structure over and covering a preexisting opening in the cabinet door, the preexisting opening being sized for a legacy keypad and the adapter being shaped to support and hold an upgraded keypad having a different size than the legacy keypad;
semi-permanently affixing the upgraded keypad to the adapter, including physically and communicatively coupling a keypad electrical interface of the upgraded keypad to an adapter port of the adapter, the communicative coupling facilitating an exchange of signals;
extending an electrical conductor portion of the adapter through an aperture in the mounting structure for allowing access to an electrical conductor of the electrical conductor portion via the preexisting opening; and
communicatively coupling the electrical conductor adapter to the adapter port and to a VFD electrical interface of the VFD cabinet for facilitating an exchange of signals.

14. The method of claim 13, the communicative coupling of the electrical conductor and the adapter port is performed inside a protected area defined by at least a housing of the electrical conductor portion, and the communicative coupling of the electrical conductor to the VFD electrical interface for exchanging signals is performed outside the protected area.

15. The method of claim 13, further comprising
securing the electrical conductor portion to the mounting structure for stability and support while preserving access to at least one conductor port that facilitates one or more of connecting the electrical conductor to ground and the communicative coupling with the VFD electrical interface.

16. The method of claim 13, wherein the affixing the keypad to the keypad adapter assembly is a tool-free process.

17. The method of claim 13, further comprising sealing the preexisting opening to protect an interior of the VFD cabinet.

18. The method of claim 13, further comprising removing a semi-permanently affixed legacy keypad assembly mounted over the preexisting opening of the cabinet door.

19. An upgraded VFD cabinet comprising:
a variable frequency drive (VFD) cabinet housing one or more VFDs;
a cabinet door of the cabinet, the cabinet door having a preexisting opening sized for a legacy keypad;
a mounting structure configured to be semi-permanently affixed to a front face of the cabinet door and to cover the preexisting opening in the cabinet door;
an adapter having a front face that is shaped to support and hold an upgraded keypad having a different size than the legacy keypad, the adapter being configured to be permanently or semi-permanently affixed to the mounting structure, wherein the adapter includes:
an adapter port that mates with a keypad electrical interface of the upgraded keypad for establishing a communicative coupling for exchanging signals between the adapter port and the keypad electrical interface; and
an electrical conductor portion having an electrical conductor configured to communicatively couple the adapter port to a VFD electrical interface of the VFD cabinet for exchanging signals.

20. The upgraded VFD cabinet of claim 19, wherein the communicative coupling of the electrical conductor and the adapter port is performed inside a protected area defined by at least a housing of the electrical conductor portion and the communicative coupling of the electrical conductor and the VFD electrical interface is performed outside the protected area.
